(19) United States
(12) Patent Application Publication
(10) Pub. No.: US 2025/0258998 A1
(43) Pub. Date: Aug. 14, 2025

(54) INPUT MECHANISM FOR GENERATIVE MODELS

(71) Applicant: GOOGLE LLC, Mountain View, CA (US)

(72) Inventors: Federico Villa, Brooklyn, NY (US); Dominik Rabiej, New York, NY (US); Cheng Sheng, Cupertino, CA (US); Gautam Shende, Mountain View, CA (US); Carla Echevarria, New York, NY (US); Paulo Melchiori, San Francisco, CA (US); Aona Yang, San Francisco, CA (US); James Zanoni, Upper Saddle River, NJ (US); Teghan Tracy, Boulder, CO (US); Keshav Dhandhania, San Mateo, CA (US); Gianluca Martini, Lugano (CH); Elliot Lim, Menlo Park, CA (US); Chi Gao, Mountain View, CA (US)

(21) Appl. No.: 18/441,785

(22) Filed: Feb. 14, 2024

(51) Int. Cl. G06F 40/20

(52) U.S. Cl. CPC G06F 40/20

(57) ABSTRACT

Implementations relate to a method implemented by one or more processors, the method including: receiving natural language (NL) based input associated with a client device; generating a refined input prompt corresponding to the NL based input based on first large language model (LLM) output generated based on processing at least the NL based input using a LLM; causing the refined input prompt to be rendered at the client device; responsive to user input received at the client device indicative of an acceptance of the refined input prompt, generating responsive content to the NL based input based on second LLM output generated based on processing the refined input prompt using the LLM; and causing the responsive content to the NL based input to be rendered at the client device.

### BACKGROUND

Various generative models have been proposed that can be used to process natural language (NL) content and/or other input(s), to generate output that reflects generative content that is responsive to the input(s). For example, large language models (LLMs) are particular types of machine learning models that can perform various natural language processing (NLP) tasks, such as language generation, machine translation, and question-answering. These LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a language generation task, these LLMs can process a natural language (NL) based input that is received from a client device, and generate an NL based output that is responsive to the NL based input and that is to be rendered at the client device.

In some cases, an LLM can include millions of parameters, hundreds of millions of parameters, billions of parameters, or even one hundred billion or more parameters. As such, given the large numbers of parameters included in an LLM, performance of NLP tasks using an LLM can consume relatively large amounts of resources (e.g., in terms of computing resources used in completing the NLP task, time taken to complete performance of the NLP task, energy consumed to complete performance of the NLP task, etc.). It is therefore beneficial in terms of computational resource usage for LLMs to generate responses to NL based inputs that do not necessitate additional follow-up NL based inputs.

### SUMMARY

Implementations disclosed herein relate to enriching (or otherwise termed, refining) input provided by a user for an LLM. Since the input has been enriched, responses to the input (e.g., generated utilizing an LLM) can be more relevant to achieving the user's intended outcomes from the interaction. For instance, an initial query entered by a user may be deficient in one or more manners. For instance, an initial query may include a number of ambiguities, or may lack details for completing the user's intended task or may otherwise lack critical information. As such a response generated using such an initial query may be unsatisfactory (e.g., resulting in subsequent computationally expensive follow up interactions to complete the user's intended task). Implementations described herein can enable an initial query to be enriched (e.g., utilizing an LLM) to correct such deficiencies. As such, a response generated based on processing the enriched input can be expected to be highly relevant to the user's intended outcome from the interaction (e.g., and therefore minimizing subsequent computationally expensive follow up interactions).

As an example, an initial query of “add bedroom light” may be provided by a user. This initial query includes a number of ambiguities, and lacks critical information as well as any detail, and in fact doesn't even clearly specify the desired task to be completed. For instance, it is not clear if the user wants to configure a smart device (e.g., a smart light device) or add a light to a shopping list or shopping cart, it is not clear which bedroom the user is referencing, etc. As such, it is unlikely that the user's intended outcome would be achieved based on only this initial input. However, according to implementations described herein, the initial query can be enriched to address these deficiencies. As described herein, in some implementations, this enriching can be based on contextual information, such as data associated with a user profile of the user (e.g., the existence of a smart home ecosystem including a device group named “master bedroom” associated with the user), historical conversational data (e.g., if the user mentioned in a previous input that they have added a new smart light device to their master bedroom), etc.

For instance, following the above example, the initial query could be enriched using the techniques described herein to read “Help me to configure my smart home ecosystem. An unregistered smart light device is located in the master bedroom. Please detect and register this device with the smart home ecosystem, and add it to the device group named “master bedroom”. Please name the new device in accordance with the naming scheme of the “master bedroom” device group and apply all routines associated with the other smart light devices in the “master bedroom” device group. Show me any other configuration settings available for the new device”. As such, a response generated based on processing this enriched input can be expected to be highly relevant to the user's intended outcome from the interaction (e.g., and therefore minimizing subsequent computationally expensive follow up interactions).

In these and other manners, a user's intended outcome can be quickly and efficiently achieved utilizing an LLM, with the user needing only to provide an initial input, which might be deficient in one or more manners. This enables users to provide inputs which are relatively simple in terms of the numbers of characters to achieve their intended outcomes. As such, for a given intended outcome, the number of inputs (e.g., keystrokes on a keyboard) required by a user, and the associated computational resources required to facilitate these inputs, can be reduced.

In other words, the techniques described herein can be said to provide a mechanism which enables user input. For instance, the techniques described herein can be said to assist the user in entering text by providing a predictive input mechanism (e.g., the enriched, or refined, input can be said to be predicted based on the initial input).

Furthermore, determining the content of an input to an LLM to achieve a particular outcome can require trial and error, and/or can require high levels of skill, training, and/or familiarity with the LLM (or LLMs in general). By enriching (or refining) an initial input from a user (who may not be an expert), the techniques described herein can mitigate these obstacles. Furthermore, by presenting the enriched input to the user and allowing further editing by the user, the user can retain control and knowledge of the information that is provided to the LLM when generating responsive content whilst being guided throughout the interaction, and can additionally be educated as to how to effectively interact with the LLM. In other words, the techniques described herein can be said to assist the user in performing a technical task by means of a guided human-machine interaction process.

Implementations described herein can also serve to reduce the number of follow-up inputs that may be received by an LLM. Since the input processed by the LLM to generate responsive content has been refined (or enriched), the responsive content can be assumed to be highly relevant to achieving the user's intended outcome (at least relative to the initial input provided by the user). As such, it is less likely that the generated responsive content will prompt subsequent follow up inputs (e.g., to correct or clarify aspects of the responsive content), at least relative to responsive content generated based on the initial input provided by the user. Although any given user may decide to provide a follow-up NL based input, any “on average” reduction in the number of follow-up NL based inputs can be hugely beneficial in terms of computational resource usage.

In addition, in some instances, the techniques described herein can be used as part of an NL based response system to be used for conducting a dialog (e.g., including multiple inputs and responses) with a human user. For instance, the NL based response system can be provided as part of an automated assistant, a chat bot, etc. In some cases, the user can provide one or more commands to be fulfilled as part of the dialog (e.g., to control a smart device, to generate code, to generate commands to control a robot, to assist with navigation in a vehicle, etc.). As such, use of the techniques described herein can also assist the user in performing these technical tasks by means of a continued and guided human-machine interaction process. Further, and since the responses generated using the LLM can be reliably of a higher quality, the human-machine interaction process can be concluded in a quick and efficient manner.

Some implementations described herein relate to generating a training set, and training, or fine-tuning, an LLM to refine (or enrich) an input as described herein.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of various example methods including refining a natural language based input using an LLM.

FIG. 3A, FIG. 3B, FIG. 3C, FIG. 4A, FIG. 4B, FIG. 5A, FIG. 5B, and FIG. 6 depict example client devices rendering example graphical user interfaces.

FIG. 7A depicts a flowchart that illustrates an example method for determining responsive content to a NL based input.

FIG. 7B depicts a flowchart that illustrates an example method for fine-tuning an LLM.

FIG. 8 depicts an example architecture of a computing device, in accordance with various implementations.

### DETAILED DESCRIPTION

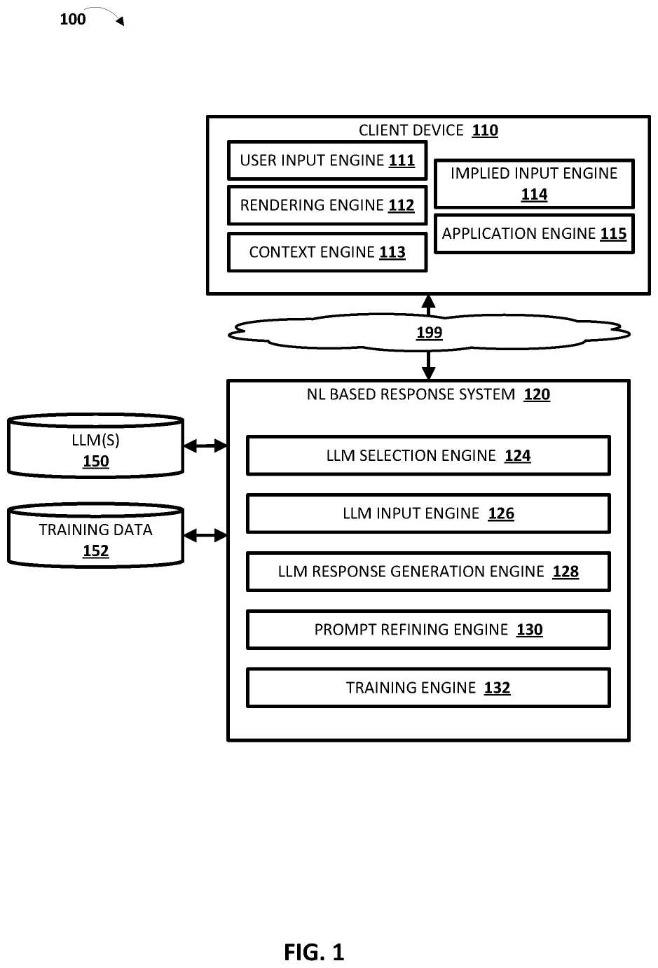

Turning to FIG. 1, a block diagram of an example environment 100 that demonstrates various aspects of the present disclosure, and in which implementations disclosed herein can be implemented is depicted. The example environment 100 includes a client device 110, and a natural language (NL) based response system 120. In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which NL based input can be submitted and/or NL based output and/or other output that is responsive to the NL based input can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser or automated assistant installed on top of the operating system of the client device 110. As another example, the application engine 115 can execute a web browser software application or automated assistant software application that is integrated as part of the operating system of the client device 110. The application engine 115 (and the one or more software applications executed by the application engine 115) can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based summary) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided). For instance, the implied query can be “patent news” based on profile data indicating interest in patents, the implied query periodically submitted, and a corresponding NL based summary result automatically rendered. It is noted that the provided NL based summary result can vary over time in view of e.g., presence of new/fresh search result document(s) over time.

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including an LLM selection engine 124, an LLM input engine 126, an LLM response generation engine 128, a prompt refining engine 130, and a training engine 132. Some of the engines can be omitted in various implementations. In some implementations, the engines of the NL-based response system are distributed across one or more computing systems.

The LLM selection engine 124 can, in response to receiving a query, determine which, if any, of multiple generative model(s) (LLM(s) 150 and/or other generative model(s)) to utilize in generating response(s) to render responsive to the query. For example, the LLM selection engine 124 can select none, one, or multiple generative model(s) to utilize in generating response(s) to render responsive to a query. The LLM selection engine 124 can optionally utilize one or more classifiers and/or rules (not illustrated).

The LLM input engine 126 can, in response to receiving a query, generate LLM input that is to be processed using an LLM in generating an NL based response to the query. As described herein, such content can include query content that is based on the query and/or additional content, such as contextual information derived from user data and/or historical conversation data.

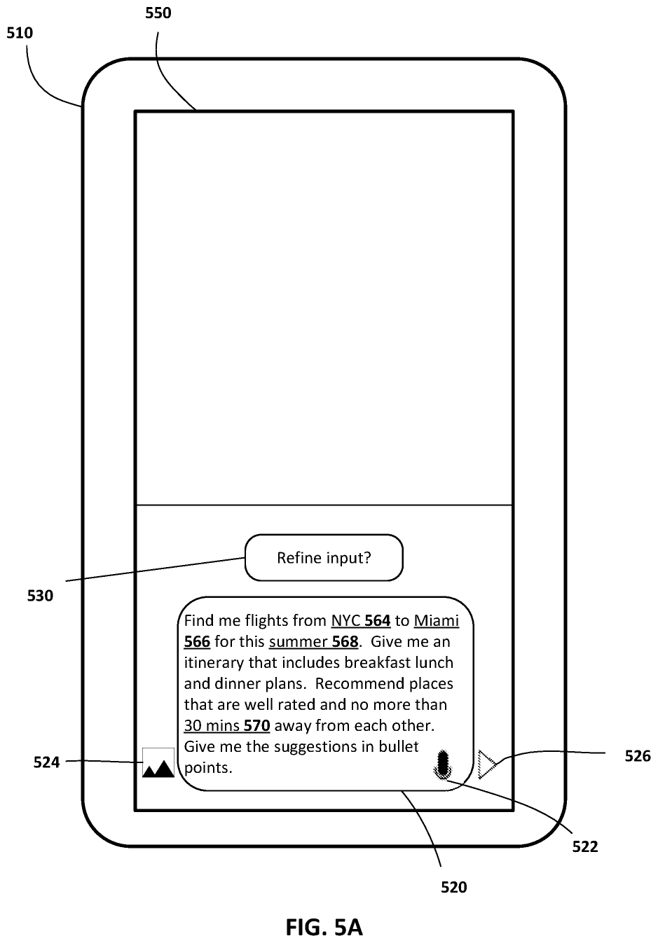

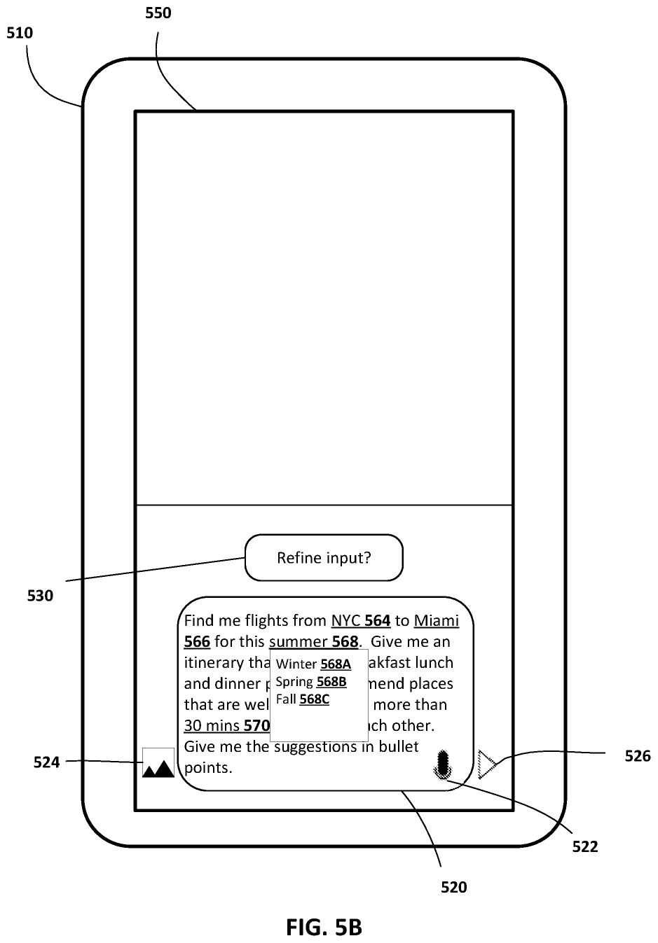

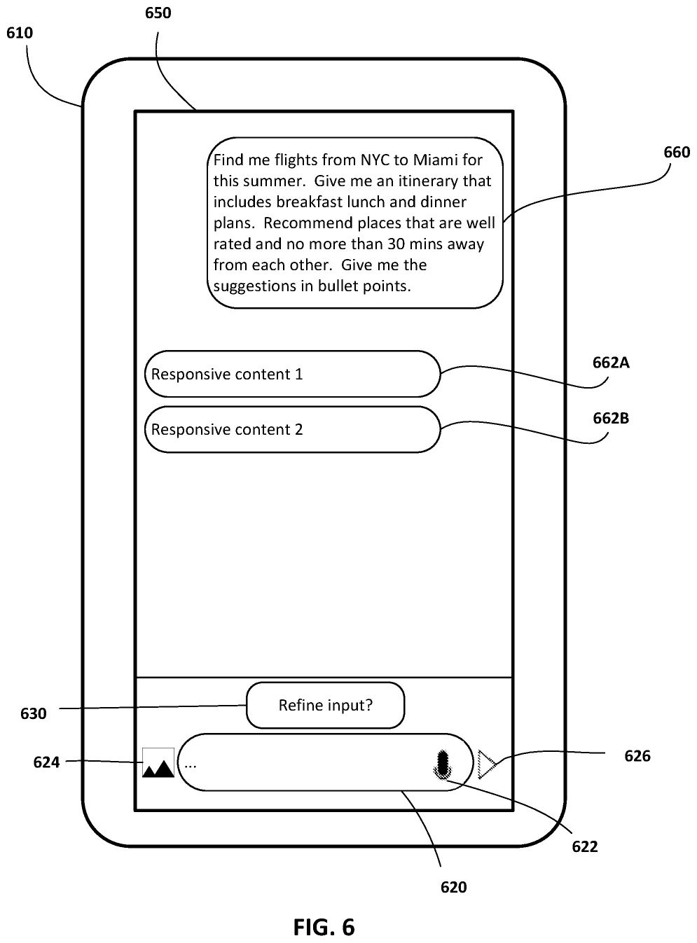

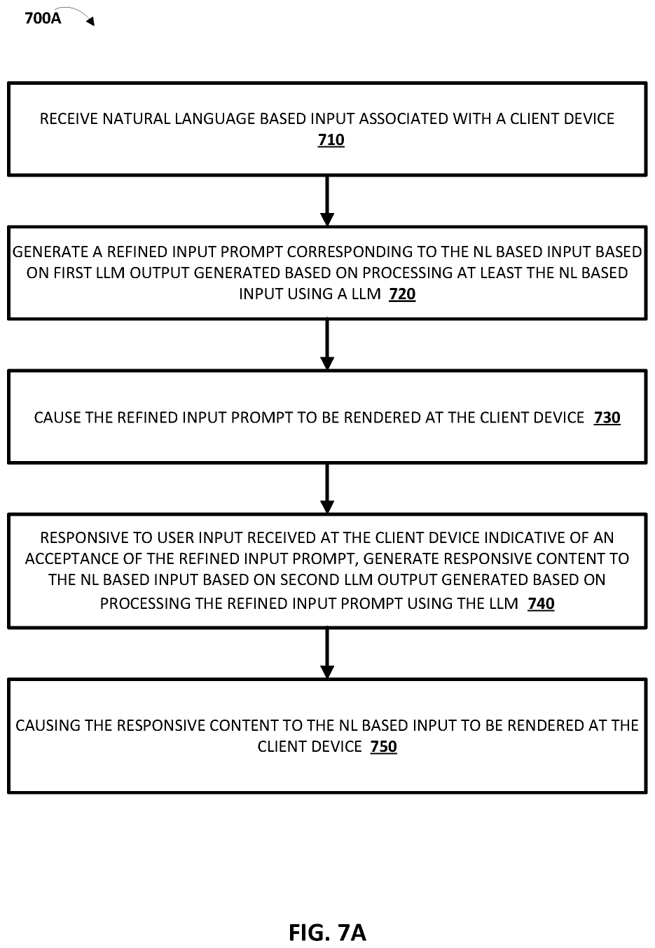

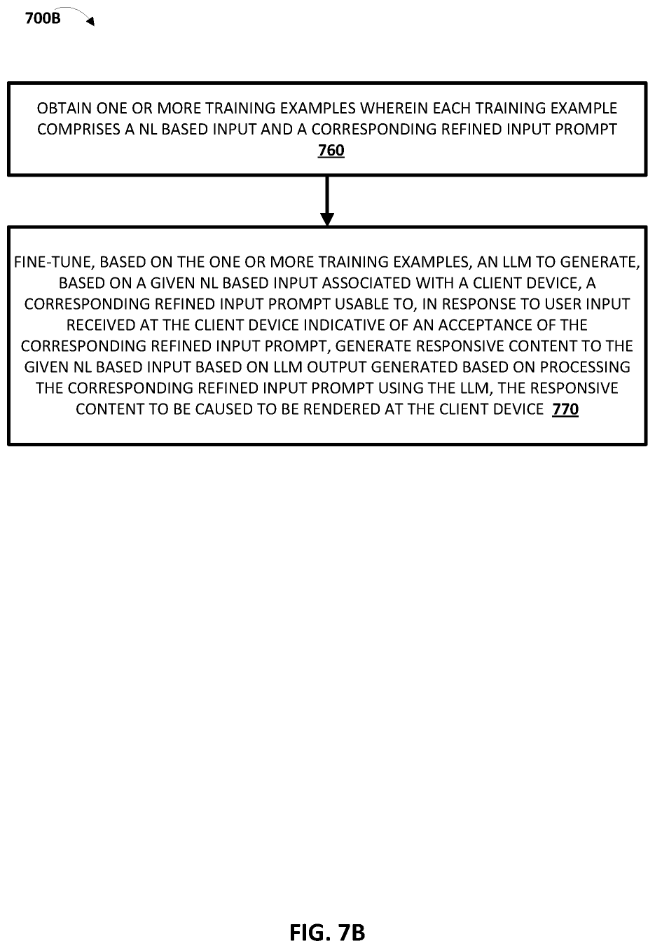

The LLM response generation engine 128 can process LLM input, which is generated by the LLM input engine 126, using an LLM to generate an NL based response. In various implementations, the LLM response generation engine 128 can perform all or aspects of blocks 720 and 740 of method 700A of FIG. 7A. The LLM response generation engine 128 can utilize one or more LLMs 150.

The prompt refining engine 130 can generate a refined input based on an NL based input prompt. For instance, the prompt refining engine 130 can process LLM input, which is generated by the LLM input engine based on an NL based input, using the LLM response generation engine 128 (e.g., utilizing one or more LLMs 150), to generate a refined input prompt. In various implementations, the prompt refining engine 130 can perform all or aspects of block 720 of method 700A of FIG. 7A.

The training engine 132 can train the one or more LLM(s) 150. For example, the training engine 132 can use training data from a training dataset (e.g., training data 152) to retrain/fine-tune parameters of one or more of the LLM(s) 150. In various implementations, the training engine 132 can perform all or aspects of block 760 and block 770 of method 700B of FIG. 7B.

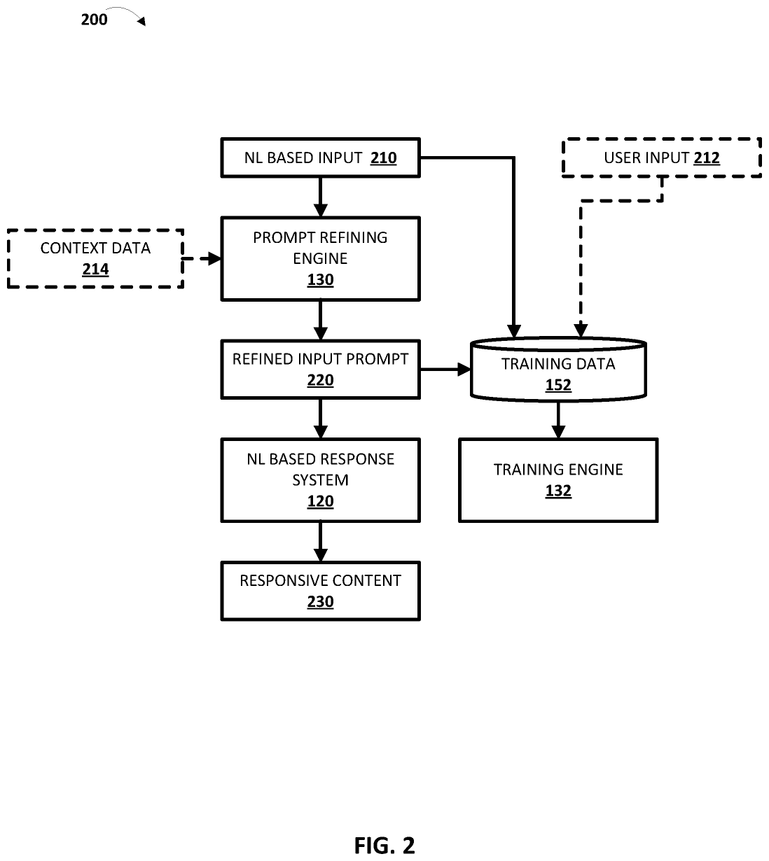

Turning now to FIG. 2, an overview 200 of various example methods including refining a natural language based input using a LLM is depicted.

As illustrated in FIG. 2, an NL based input 210 can be received (e.g., from a user of a client device 110). The NL based input 210 is, in some examples, received in the form of an input text query. The NL based input 210 can, for example, originate as text input manually by a user of a user application executed at a client device 110. Alternatively or additionally, the NL based input 210 can originate from a spoken input to a user application executed at a client device 110, e.g. a spoken query input after invoking the user application. The spoken input is converted to the input query by a speech-to-text engine running on the client device 110 (either as part of the user application, or accessible by the user application). The NL based input 210 is, in some examples, part of an ongoing human-computer dialogue, e.g., a sequence of input queries and their corresponding responses from the NL based response system 120. Although the NL based input 210 is generally described as originating from input text (or spoken input) it will be appreciated that the NL based input can originate from any suitable format (e.g., an image).

The NL based input 210 can be processed to generate a corresponding refined input prompt 220 (e.g., utilizing the prompt refining engine 130). For instance, the prompt refining engine 130 can generate, using the LLM input engine 126, LLM input based on the NL based input 210. The prompt refining engine 130 can then use the LLM response generation engine 128 to generate the refined input prompt 220 based on the LLM input (e.g., which can include, at least, the NL based input 210). For instance, the LLM response generation engine 128 can process the LLM input, using an LLM (e.g., of the LLM(s) 150) to generate LLM output corresponding to the refined input prompt 220.

The LLM input can be generated to include a request to refine a given NL based input. In some implementations, the LLM input can be tailored according to the input prompt and/or other contextual information such as the task to be completed (e.g., whether to consider context data 214, whether to indicate user-selectable terms, etc.). In some implementations, the LLM input can include one or more examples of a corresponding refined input prompt given a corresponding NL based input. For instance, these examples can be selected or curated by a human expert. In some implementations, the LLM input can be formatted according to a template. The template may not be provided by the user that provided the initial NL based input 210, and can be provided to the LLM even without the user's knowledge. The template can include, for example, a space or entry field after the request to prompt the LLM to fill in the space or entry field with output that is responsive to the request.

The refined input prompt 220 can be processed to generate responsive content 230 (e.g., by the NL based response system 120). For instance, the LLM input engine 126 can generate LLM input based on the refined input prompt 220. The LLM response generation engine 128 can then be used to generate the responsive content 230 based on processing the LLM input (which can include, at least, the refined input prompt). For instance, the LLM response generation engine 128 can process the LLM input using the LLM (e.g., the same LLM used in generating the refined input prompt 220) and/or another LLM (e.g., from LLM(s) 150) to generate LLM output corresponding to the responsive content. The responsive content 230 can include a natural language response to the refined input prompt 220 (and accordingly the NL based input 210). The responsive content 230 can then be rendered at the client device 110 (e.g., via the user application), e.g., as text in a text-based dialogue/chat application, converted to speech using a text-to-speech engine or the like.

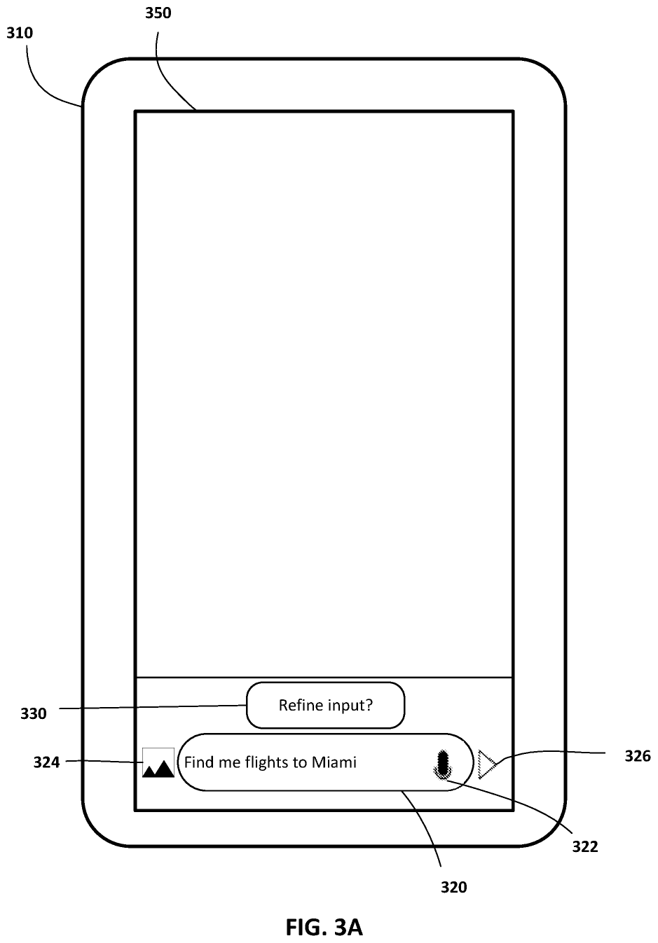

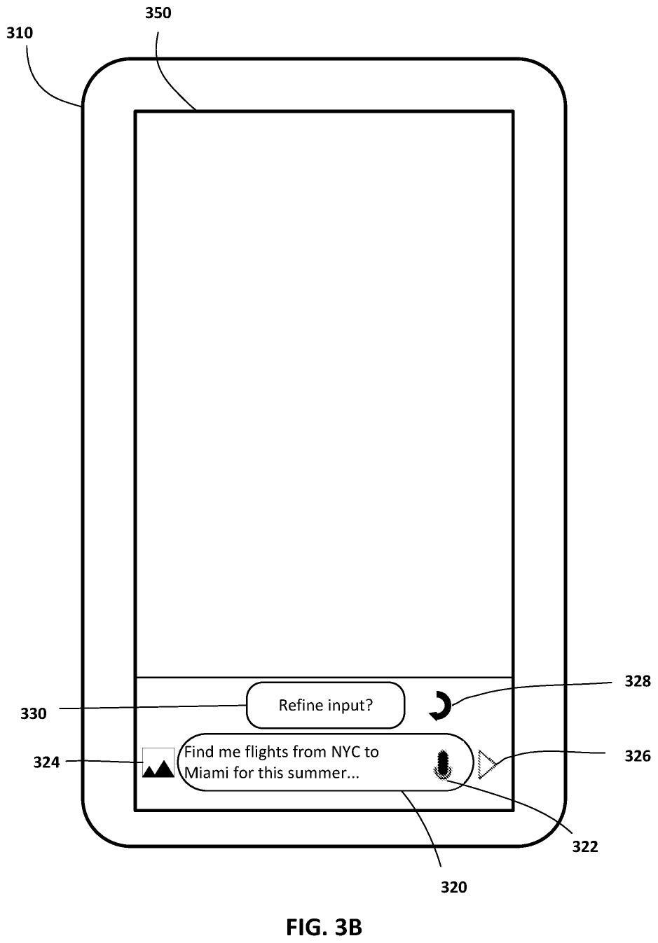

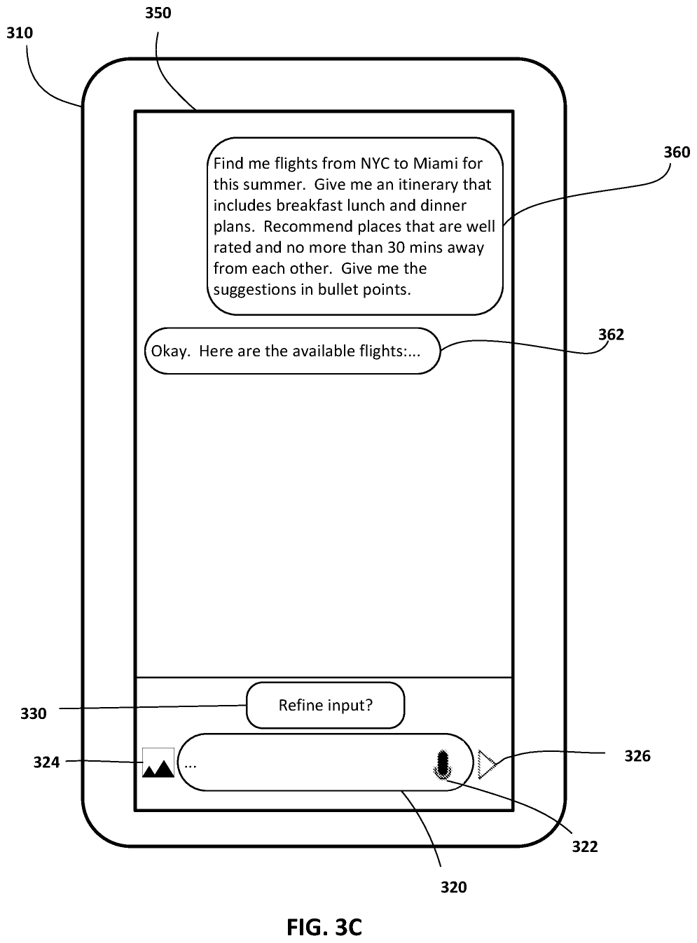

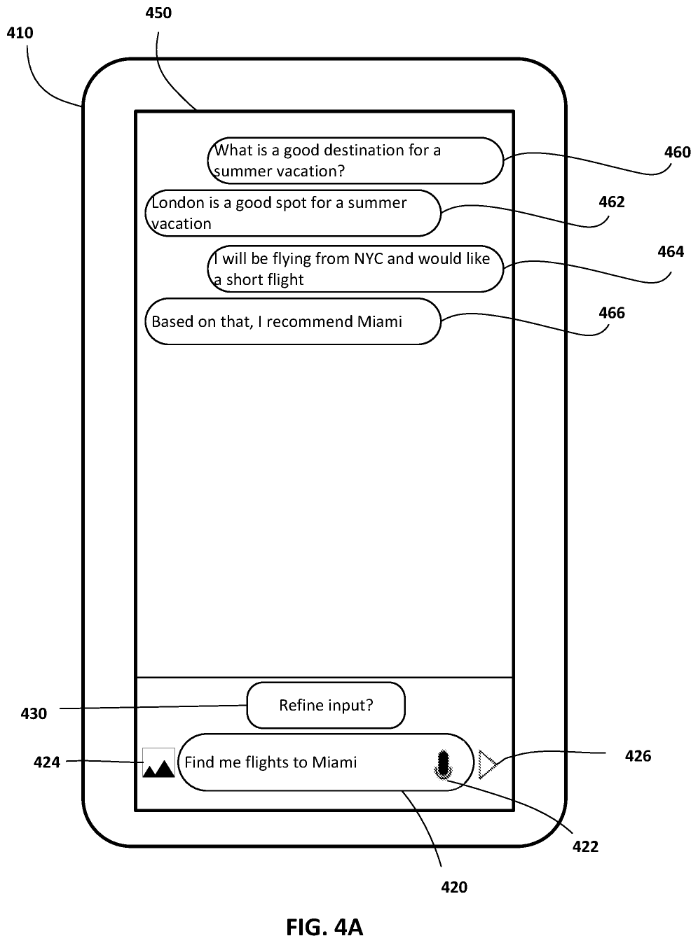

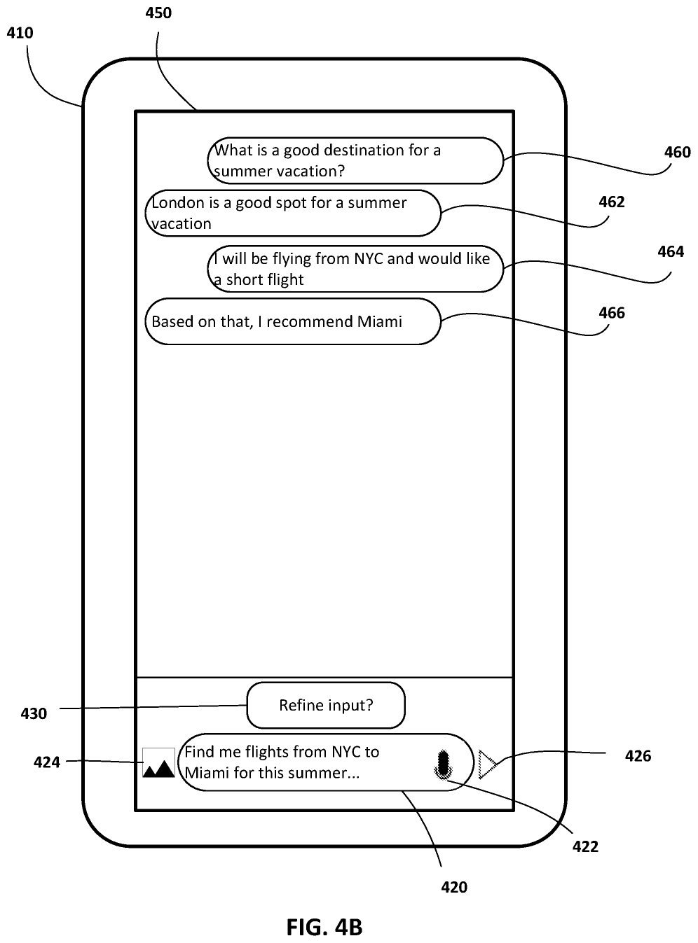

An example of an example method illustrated in FIG. 2 is described in relation to FIGS. 3A to 3C. For example, and turning to FIG. 3A, an example client device 310 (which may be similar to client device 110) rendering an example graphical user interface 350 is depicted. The graphical user interface 350 can include an entry field 320 for receiving NL based input from a user. For instance, the entry field 320 can receive text data from a virtual or physical keyboard. In some implementations the graphical user interface can include a graphical element 322 (in this case represented by a microphone icon) which, upon selection, can start recording a spoken utterance from the user (e.g., via one or more microphones of the client device 310). The spoken utterance can then be transcribed and entered into the entry field 320. In some implementations, the graphical user interface can include a graphical element 324 (in this case an image icon) which, upon selection, can enable a user to submit an image for processing (e.g., an image retrieved from storage on the client device 310, an image retrieved from the internet, etc.). In some implementations, a model can be used to generate NL based input based on a submitted image to be entered into entry field (e.g., based on text detected in the image, people and/or objects detected in the image, etc.). Graphical user interface 350 can also include graphical element 326, which, upon selection, can submit the NL based input currently displayed in the entry field 320 (or in other words, selection of the graphical element 326 can indicate acceptance of the NL based input currently displayed in the entry field 320).

In some implementations, graphical user interface 350 can include a graphical element 330. Graphical element 330 can be configured such that, upon selection, the NL based input (e.g., the text currently displayed in entry field 320) is refined (e.g., as described herein). In some implementations, graphical element 330 is only provided (e.g., or rendered) in graphical user interface 350 based on a determination that the graphical element 330 should be provided (e.g., or rendered). For instance, the determination that the graphical element 330 should be provided can be based on a quality metric of the NL based input. The quality metric can include, for instance, a length of the NL based input (e.g., currently displayed in the entry field 320). For instance, if the NL based input includes a number of characters below a minimum threshold number of characters and/or above a threshold number of characters, it can be determined not to provide the graphical element 330. As another example, the quality metric can include, for instance, an indication that the NL based input cannot be meaningfully refined. For instance, it can be determined that the NL based input cannot be meaningfully refined based on processing the NL based input by the LLM (or another model) prior to selection of the graphical element 330, or responsive to a previous selection of the graphical element 330. For instance, a previous iteration of the generation of a refined input prompt (which may have resulted in the NL based input currently included in the entry field 320) can provide metadata indicating that the NL based input cannot be meaningfully further refined, or a maximum threshold number of refining iterations may have been reached. In some implementations, it can be determined not to provide the graphical element 330 based on a determination that the text included in the entry field 320 includes harmful content. For instance, the text included in the entry field 320 can be processed by a model (e.g., which has been trained to identify harmful content) as the text is entered into the entry field 320 to generate an indication of whether the text includes harmful content. In some implementations, harmful content can be based on detecting the presence of key words. In some implementations, detection of harmful content can be performed as an intermediate step when refining the NL based input (e.g., in response to the user selecting a graphical element to cause the NL based input to be refined, but prior to the refined input prompt being generated). IF harmful content is detected, subsequent processing can be prevented and/or a warning message can be rendered to the user indicating that harmful content was identified.

As depicted in FIG. 3A, a user can enter the NL based input “Find me flights to Miami” into entry field 320. Assuming, the user then selects graphical element 330, the NL based input can be refined. As such, the graphical user interface 350 can be updated to replace the NL based input rendered in the entry field 320 with the refined input prompt (e.g., as depicted in FIG. 3B). Whilst it is generally described that the NL based input can be refined based on selection of a graphical element (e.g., in this case graphical element 330), it will be appreciated that this is not necessary. For instance, the NL based input can be refined automatically (e.g., when it is determined that the user has ceased entering text for a predetermined period of time), in response to interaction with a physical input device (e.g., selection of a key of a physical keyboard), in response to a spoken utterance, etc.

As depicted in FIG. 3B, entry field 320 now includes the text “Find me flights from NYC to Miami for this summer. Give me an itinerary that includes breakfast lunch and dinner plans. Recommend places that are well rated and no more than 30 mins away from each other. Give me the suggestions in bullet points”. This text can have been generated based on refining the NL based input previously included in the entry field 320 (as depicted in FIG. 3A) as described herein. In some implementations, the graphical user interface 350 can also be updated to include graphical element 328 which upon selection, can cause the text currently included in the entry field 320 to be reverted to the text included in the entry field prior to refining (e.g., an “undo” button). Furthermore, the text included in the entry field can be editable (e.g., via user selection and input via a virtual or physical keyboard, via one or more spoken utterances, etc.). Note that the user could further refine the text now included in the entry field 320 (e.g., by selection of the graphical element 330). However, assuming that the user indicates acceptance of the text included in the entry field 320 (e.g., based on selection of graphical element 326), the text can be submitted for processing by the NL based response system 120 (or a LLM thereof).

For instance, as depicted in FIG. 3C, the graphical user interface 350 has been updated (e.g., based on selection of graphical element 326 in FIG. 3B) to indicate the text 360 submitted to the NL based response system 120 (which was previously included in the entry field 320 in FIG. 3B). The graphical user interface 350 can additionally or alternatively be updated to include content 362 responsive to the submitted text 360 (and accordingly the initial NL based input). For instance, the responsive content 362 can include the text “Okay. Here are the available flights: . . . ”, as well as, for instance, various available flight option according to the user's specifications, an itinerary according to the user's specifications, etc.

Returning now to FIG. 2, in some implementations, the refined input prompt 220 can also be generated based on context data 214. For instance, the context data 214 can be obtained (e.g., by the prompt refining engine 130) and used to generate the LLM input (e.g., by the LLM input engine 126). The LLM input (including, at least, the NL based input 120, and the context data 214) can be processed using the LLM (e.g., by LLM response generation engine 128) to generate the refined input prompt 220.

The context data can be based on, for instance, current or recent interaction(s) via the client device 110, a location of the client device 110, profile data of a profile of a user of the client device 110 (e.g., an active user when multiple profiles are associated with the client device 110), and/or other data accessible NL based response system 120 (e.g., via the context engine 113). For instance, assuming the user has granted permissions for the NL based response system 120 to have access to such data, the context data can include a home and/or work address of the user, calendar entries associated with the user, family members names and relationships to the user, smart home configuration data associated with the user, user preference information, etc. In some implementations, the context data can include historical data associated with one or more previous turns of dialog with the user. For instance, FIGS. 4A and 4B depict an illustrative example of an input being refined based on context data being obtained from a multi-turn dialog session.

Turning to FIG. 4A, an example client device 410 (which may be similar to client device 110 and client device 310) rendering an example graphical user interface 450 is depicted. The graphical user interface 450 can be largely similar to graphical user interface 350 of FIG. 3A, and include entry field 420 which is largely similar to entry field 320 of FIG. 3A, and graphical elements 422, 424, 426, and 430 which are largely similar to graphical elements 322, 324, 326, and 330 of FIG. 3A.

As depicted in FIG. 4A, the user and the NL based response system 120 have engaged in a multi-turn dialog. The multi-turn dialog is represented by user submission 460 including the text “What is a good destination for a summer vacation?”, response 462 including the text “London is a good spot for a summer vacation”, user submission 464 including the text “I will be flying from NYC and would like a short flight”, and response 466 including the text “Based on that, I recommend Miami”. As also depicted in FIG. 4A, similarly to FIG. 3A, the user has entered the NL based input “Find me flights to Miami”.

Turning to FIG. 4B, assuming the user has requested that the NL based input be refined (e.g., similarly to FIG. 4B), the NL based input “Find me flights to Miami” can be replaced with the text “Find me flights from NYC to Miami for this summer. Give me an itinerary that includes breakfast lunch and dinner plans. Recommend places that are well rated and no more than 30 mins away from each other. Give me the suggestions in bullet points.”. The graphical user interface 450 can be updated accordingly.

In this case, it can be assumed that the NL based input was refined based at least in part on context data, including historical data associated with one or more previous turns of the dialog between the user and the NL based input system 120 (e.g., an indication that particular information was specified by the user and/or provided by the NL based response system in a previous turn of dialog). For instance, the context data can include an indication that the user will be flying from NYC (e.g., based on input 464) and the refined input can include a request for flights from NYC accordingly. The context data can additionally or alternatively include an indication that the user is looking for flights in the summer (e.g., based on input 460), and the refined input can include a request for flights in the summer accordingly. The context data can additionally or alternatively include an indication that the user is going on vacation (e.g., based on input 460), and the refined input can include a request for an itinerary for various meal plans accordingly. The context data can additionally or alternatively include an indication that the user typically does not travel more than 30 minutes for a meal, and/or that they prefer information presented as bullet points (e.g., based on preference data associated with the user, recorded historical behavior of the user, etc.). The refined input can include these constraints accordingly. In this way, the user need not repeat information submitted to the NL based response system 120.

Returning now to FIG. 2, in some implementations, one or more terms (e.g., characters, words, groups of words, sentences, etc.) of the refined input prompt 220 can be selected to be user selectable terms. An indication of the user selectable terms can then be rendered. Upon user interaction with a particular user selectable term (e.g., selection, hovering over with a cursor, etc.), one or more alternative terms to the particular user selectable term can be rendered. The alternative terms can be selectable such that, upon selection, the selected alternative term can replace the corresponding user selectable term.

Selection of the user selectable terms can be based on, for instance, metadata generated with the refined input prompt 220 (e.g., by the LLM) indicative of the user selectable terms. For instance, the LLM can be fine-tuned to identify user selectable terms in a given refined input prompt and/or the LLM input processed by the LLM to generate the refined input can include a request to identify user selectable terms. Additionally or alternatively, the user selectable terms can be selected subsequent to generation of the refined input prompt 220 (e.g., separately to generation of the refined input prompt 220 by another model). In some implementations, the user selectable terms can be selected based on a confidence measure associated with the terms. For instance, if a confidence measure associated with a given term is below a threshold confidence, it can be determined to select the given term as a user selectable term (e.g., since it may be more likely that the user will want to change that term). As another example, the user selectable terms can be selected based on identifying that the term in question has at least one likely alternative. For instance, the term “Monday” may be selected as a user selectable term based on there being alternative terms which can be presented if the user requests, and that one of the alternative terms will likely be correct (e.g., because there is a finite and discrete number of alternatives, because the user has previously selected a particular alternative, etc.). As another example, the user selectable terms can be selected based on context data. For instance, the term “daughter” may be selected as being user selectable based on it being determined (e.g., based on user data) that the user often travels with a person associated with the title “daughter”, and occasionally additionally with a person associated with the title “son”. In this case, the alternative terms provided to the user might include, for instance, “daughter and son”, “son”, “alone”, etc.

Determination of the alternative terms can be performed in any suitable manner. For instance, similarly to selection of the user selectable terms, the alternative terms can be indicated in metadata generated with the refined input prompt 220. Additionally or alternatively, the alternative terms can be determined subsequent to generation of the refined input prompt 220 (e.g., prior to or upon interaction with the corresponding user selectable term). For instance, the alternative terms can be determined using another model (e.g., based on processing the corresponding user selectable term). In some implementations, the alternative terms can be determined using context data. For instance, following the example above where the term “daughter” is selected as a user selectable term, based on user data indicating that the user often travels with a person associated with the title “daughter”, and occasionally additionally with a person associated with the title “son”, the alternative terms provided to the user might include, for instance, “daughter and son”, “son”, “alone”, etc. In some implementations, user selection of a particular alternative can be stored for future refinement of NL based inputs. For instance, again following the example above, assuming the user selects the alternative term “daughter and son”, an indication of this selection can be stored and provided when subsequently generating refined input prompts such that they include “daughter and son” rather than “daughter” (which might have been included absent this indication).

For example, FIGS. 5A and 5B illustrate an example of user selectable terms and corresponding alternative terms being rendered to the user. Turning to FIG. 5A, an example client device 510 (which may be similar to client device 110 and client device 310) rendering an example graphical user interface 550 is depicted. The graphical user interface 550 can be largely similar to graphical user interface 350 of FIG. 3B, and include entry field 520 which is largely similar to entry field 320 of FIG. 3B, and graphical elements 522, 524, 526, and 530 which are largely similar to graphical elements 322, 324, 326, and 330 of FIG. 3B.

As depicted in FIG. 5A, the entry field 520 includes the refined input prompt “Find me flights from NYC to Miami for this summer. Give me an itinerary that includes breakfast lunch and dinner plans. Recommend places that are well rated and no more than 30 mins away from each other. Give me the suggestions in bullet points.”. As also depicted in FIG. 5A, graphical user interface 550 also includes indications of various user selectable terms 564, 566, 568, 570. In FIG. 5A, the user selectable terms are indicated to the user based on the terms being underlined (namely “NYC”, “Miami”, “summer”, “30 mins”). However, it will be appreciated that any suitable manner of indicating the user selectable terms can be used.

Turning now to FIG. 5B, the graphical user interface 550 has been updated to include various alternative terms 568A, 568B, 568C to the corresponding user selectable term 568. In particular, the alternative terms “Winter” 568A, “Spring” 568B, and “Fall” 568C can be presented to the user as alternatives to the user selectable term “summer” 568. The graphical user interface 550 can be updated in this manner based on detecting a user interaction with (e.g., a user selection of) the user selectable term summer 568. Upon selection of one of the alternative terms 568A, 568B, 568C, the corresponding user selectable term 568 can be replaced with the selected one of the alternative terms 568A, 568B, 568C. The graphical user interface 550 can be updated accordingly to include the selected one of the alternative terms 568A, 568B, 568C in place of the user selectable term 568 in the entry field 520.

Returning now to FIG. 2, in some implementations, the NL based input 210 can be stored together with the refined input prompt 220 as a training example (e.g., in training data database 152). Furthermore, in some implementations, additional signal information (e.g., from one or more user inputs 212 as described herein) can be stored in the corresponding training example.

For instance, in some implementations, multiple options of responsive content 230 can be generated and rendered to the user. For instance, since LLMs can operate in a probabilistic manner, a plurality of refined input prompts 220 can be generated (e.g., utilizing the prompt refining engine 130 as described herein), and can be expected to differ from one another, even when generated using the same inputs (e.g., based on the same NL based input 210). As such, each of the multiple options of responsive content 230 can be generated based on a respective one of the plurality of refined input prompts. Additionally or alternatively, the multiple options of responsive content 230 can include responsive content generated based on processing the NL based input 210 directly (e.g., by the LLM). For instance, a first option of responsive content 230 can be generated based on the refined input prompt 220 (as already described herein), and a second option of responsive content can be generated based on processing the NL based input 210 directly. The multiple options of responsive content 230 can then be rendered at the client device 110. Each of the multiple options of responsive content 230 can be selectable (e.g., to select which option(s) best achieves the user's intended outcome, to determine which option(s) to continue with in a multi-turn dialog, etc.). An indication of the selected option(s) can be stored in a corresponding training example (e.g., as user input 212 in the training data database 152). For instance the indication of the selected option(s) can be stored along with the NL based input 210 and the corresponding refined input prompt 220 (e.g., the refined input prompt used to generate the responsive content associated with the selected option) as a training example. The indication can be taken as an additional signal that the corresponding refined input prompt 220 was an appropriate refined input prompt given the NL based input 210 (and optionally the available context data 214) (e.g., because the user explicitly indicated that the resulting responsive content achieved their intended outcome, at least relative to the other options provided).

Although only one example of user input 212 has been described here, it will be appreciated that any suitable user input 212 can be used for these purposes, as described in more detail herein. For instance, the user can be provided with a number of options of refined input prompts, and can provide user input to select one (or more) of the refined input prompts. Other examples can include, for instance, user input to edit the refined input prompt, user input to revert from the refined input prompt to the NL based input, user input to provide follow up NL based inputs (e.g., to clarify or correct aspects of responsive content), etc.

An example of rendering multiple options to a user is depicted in FIG. 6. Turning to FIG. 6, an example client device 610 (which may be similar to client device 110 and client device 310) rendering an example graphical user interface 650 is depicted. The graphical user interface 650 can be largely similar to graphical user interface 350 of FIG. 3C, and include entry field 620 which is largely similar to entry field 620 of FIG. 3C, and graphical elements 622, 624, 626, and 630 which are largely similar to graphical elements 322, 324, 326, and 330 of FIG. 3C.

As depicted in FIG. 6, the user may have submitted the text 660 “Find me flights from NYC to Miami for this summer. Give me an itinerary that includes breakfast lunch and dinner plans. Recommend places that are well rated and no more than 30 mins away from each other. Give me the suggestions in bullet points.” to the NL based response system 120 (e.g., as described in relation to FIGS. 3A to 3C). Based on the user submitting the text 660, a first option of responsive content 662A and a second option of responsive content 662B can be provided in the graphical user interface 650. The first option of responsive content 662A can be generated based on processing the submitted text 660 (e.g., which may be refined based on an initial NL based input, e.g., as described in relation to FIGS. 3A to 3C). In some implementations, the second option of responsive content 662B can be generated based on processing the NL based input used to generate the submitted text 660 (e.g., by refining the NL based input). In some implementations, the second option of responsive content 662B can be generated based on processing an alternative refined input prompt generated based on processing an initial NL based input. For instance, since LLMs behave in a probabilistic manner, it can be expected that when a plurality of refined input prompts are generated based on the same NL based input, they will differ from one another.

The various options 662A 662B of responsive content can be presented as user selectable elements. The user selectable elements can be configured such that selection of an option is indicative of the user indicating that the selected option better achieves their intended outcome. For instance, the selected option can be selected to be continued with in a multi-turn dialog (e.g., the graphical user interface 650 can be updated to retain the selected option and remove the option which has not been selected). As another example, the responsive content can include one or more actions which can be executed by the NL based response system 120, and selection of an option can cause the NL based response system 120 to cause the corresponding actions to be executed. Responsive to selection of one of the options 662A 662B, an indication of the selection can be stored as training data, as described herein.

Returning now to FIG. 2, in some implementations, training data obtained from a training data database (e.g., training data database 152) can be used to train one or more of the LLMs and/or one or more further LLMs (e.g., utilizing the training engine 132). For instance, the LLM can be fine-tuned to generate refined input prompts based on a given NL based input. In some examples, the training data can be used to fine-tune an existing LLM, e.g., one of the LLM(s) 150. Alternatively or additionally, the training data can be used to train a new LLM from scratch. The training data can be used by the training engine 132 to determine a set of parameter updates for parameters of one or more of the LLM(s) 150 or a further LLM.

The training data can include one or more training examples. Each training example can include an NL based input and a corresponding refined input prompt. The training examples can be used during fine-tuning the LLM. Typically, the training examples can be assumed to include refined input prompts which accurately reflect the intended input based on the corresponding NL based input. As such, the LLM can be fine-tuned towards generating similar refined input prompts given the same NL based input (e.g., by providing a reward during fine-tuning when the LLM generates a semantically similar refined input prompt given the same NL based input). However, in some implementations, some or all of the training examples can include prompts which do not accurately reflect the intended input based on the corresponding NL based input. In these cases, the LLM can be fine-tuned away from generating similar refined input prompts given the same NL based inputs of these training examples (e.g., by providing a negative reward or penalty during fine-tuning when the LLM generates a semantically similar refined input prompt given the same NL based input).

In some implementations, the training examples can include additional signals (e.g., based on user input 212 received at the client device 110) which can be used during the fine-tuning of the LLM. As an example, the additional signals can include an indication of whether the user manually edited the refined input prompt. For instance, if the user manually edited the refined input prompt, this may be an indication that the refined input prompt accurately reflects the user's intended input based on the initial NL based input. As another example, the additional signals can include an indication of whether the user reverted a generated refined input prompt to their initial NL based input (e.g., by selecting an “undo button”). For instance, it can be assumed that if the user reverted the refined input prompt to their initial NL based input, this is an indication that the refined input prompt did not accurately reflect the user's intended input. As another example, the additional signals can include an indication of whether the user selected responsive content generated based on processing the refined input prompt (e.g., when also provided with responsive content generated based on processing the NL based input and/or another refined input prompt). For instance, it can be assumed that if the user selected the responsive content generated based on processing the refined input prompt, this is an indication that the refined input prompt did accurately reflect the user's intended input. As another example, the additional signals can include an indication of whether one or more follow up inputs were received from the user. For instance, if the user had to clarify or correct one or more aspects in follow up NL based inputs, this may be an indication that the refined input prompt was not representative of the user's intended input based on the initial NL based input. Although a number of additional signals have been discussed, it will be appreciated that any suitable additional signal can be used.

It will be appreciated that the LLM can be fine-tuned in any suitable manner. For instance, an NL based input and a corresponding refined input prompt can be obtained from a particular training example (which can be retrieved, e.g., from training data database 152). A refined input prompt can be generated based on processing the NL based input using the LLM. The generated refined input prompt can then be compared with the obtained refined input prompt to generate a training loss. Comparing the generated refined input prompt with the obtained refined input prompt can include, for instance, tokenization, natural language understanding (NLU), natural language processing (NLP), etc. For instance, rather than the refined input prompts themselves being compared, embeddings generated (in any suitable way) based on the responses can be compared to generate the training loss. Moreover, the LLM can be updated based on the training. In some implementations, additional signal(s) (e.g., as described herein) can be obtained from the training example as well, and used in generating the training loss.

Once the LLM has been fine-tuned, the fine-tuned LLM can be deployed for use in generating refined input prompts based on NL based input. For instance, the NL based response system 120 can be updated with the fine-tuned LLM. In some implementations, the fine-tuned LLM can be used in further generation of training data and fine-tuning (e.g. as described herein).

Alternatively or additionally, the training examples can be used to evaluate the performance of the one or more LLMs 150, or a further LLM. For instance, the performance of the LLM can be evaluated based on the training examples, e.g., by human evaluation of the refined input prompts or by comparing the refined input prompts output by the LLM to ground truth outputs provided by a human annotator.

Turning now to FIG. 7A, a flowchart illustrating an example method 700A for determining responsive content to a NL based input, in accordance with various implementations, is depicted. For convenience, the operations of the method 700A are described with reference to a system that performs the operations. This system of the method 700A includes one or more processors, memory, and/or other component(s) of computing device(s) (e.g., client device 110, NL based response system 120, computing device 810, one or more servers, and/or other computing devices). Moreover, while operations of the method 700A are shown in a particular order, this is not meant to be limiting. One or more operations may be reordered, omitted, and/or added.

At block 710, the system receives NL based input associated with a client device (e.g., in the same or a similar manner as described with respect to FIGS. 1 and 2 and/or in similar manners).

In some implementations, the system can cause a graphical user interface element to be rendered at the client device. The graphical user interface can be configured to cause, upon selection, a refined input prompt to be generated (e.g., as described below in relation to block 720). In some implementations, the system can make a determination as to whether to cause rendering of the graphical user interface element. The determination can be based on, for instance, a quality metric of the NL based input and/or on determining whether the NL based input includes harmful content.

At block 720, the system generates a refined input prompt corresponding to the NL based input based on first LLM output generated based on processing at least the NL based input using an LLM.

In some implementations, the system can generate the refined input prompt based on processing at least (i) the NL based input and (ii) one or more exemplary refined input prompts using the LLM. Additionally or alternatively, the LLM can be fine-tuned to generate, for a given NL based input, a corresponding refined input prompt.

In some implementations, the system can generate the refined input prompt based on processing at least (i) the NL based input and (ii) context data using the LLM. The context data can include user data associated with a user of the client device. Additionally or alternatively, the context data can include historical data associated with one or more previous turns of dialog with a user of the client device.

At block 730, the system causes the refined input prompt to be rendered at the client device.

In some implementations, the system can select one or more terms of the refined input prompt to be user selectable terms. The system can then cause an indication of the user selectable terms from among the refined input prompt to be rendered at the client device. In some implementations, the one or more terms of the refined input prompt to be user selectable terms can be selected based on metadata included in the first LLM output.

In some implementations, the system can detect user interaction with a particular user selectable term. In response, the system can cause one or more alternative terms corresponding to the particular user selectable term to be rendered at the client device. The system can then detect user selection of a particular alternative term at the client device. In response, the system can replace the particular user selectable term with the particular alternative term in the refined input prompt to generate an updated refined input prompt. The responsive content can then be generated based on processing the updated refined input prompt (e.g., in response to user input received at the client device indicative of an acceptance of the updated refined input prompt). In some implementations, the system can store an indication of the selection of the alternative term for use in generating subsequent refined input prompts using the LLM.

At block 740, the system, responsive to user input received at the client device indicative of an acceptance of the refined input prompt, generates responsive content to the NL based input based on second LLM output generated based on processing the refined input prompt using the LLM.

In some implementations, responsive to the user input received at the client device indicative of the acceptance of the refined input prompt, the system can store the refined input prompt and the NL based input together as a training example for use in fine-tuning the LLM. In some implementations, responsive to a user input received at the client device indicative of a request to revert to the NL based input (e.g., selection of an “undo” button), the system can bypass storing the refined input prompt and the NL based input as a training example (or store the training example as an example of a poor refined input prompt).

At block 750, the system causes the responsive content to the NL based input to be rendered at the client device.

In some implementations, the system can generate second responsive content to the NL based input based on third LLM output generated based on processing the NL based input using the LLM. The second responsive content to the NL based input can be rendered at the client device. The system can then detect user input indicative of a selection of one of the first responsive content and the second responsive content at the client device. In response to the first responsive content being selected, the system can store the refined input prompt and the NL based input together as a training example for use in fine-tuning the LLM to generate, based on a given NL based input, a corresponding refined input prompt. In response to the second responsive content being selected, the system can bypass storing the refined input prompt and the NL based input together as a training example, or the refined input prompt and the NL based input can be stored together as an example illustrating a poor quality refined input prompt.

In some implementations, the user can modify the refined input prompt at the client device to generate an updated refined input prompt. Responsive to user input received at the client device indicative of an acceptance of the updated refined input prompt, the system can generate responsive content to the NL based input based on processing the updated refined input prompt using the LLM. The responsive content to the NL based input can then be rendered at the client device; and the system can store the updated refined input prompt and the NL based input together as a training example for use in fine-tuning the LLM.

In some implementations, the system can fine-tune the LLM to generate, based on a given NL based input, a corresponding refined input prompt, based on one or more training examples, wherein each training example includes a NL based input and a corresponding refined input prompt (e.g., in the same or similar manner to that described in relation to FIG. 7B, and/or in any other manners described herein).

FIG. 7B depicts a flowchart that illustrates an example method.

Turning now to FIG. 7B, a flowchart illustrating an example method 700B for fine-tuning an LLM, in accordance with various implementations, is depicted. For convenience, the operations of the method 700B are described with reference to a system that performs the operations. This system of the method 700B includes one or more processors, memory, and/or other component(s) of computing device(s) (e.g., client device 110, NL based response system 120, computing device 810, one or more servers, and/or other computing devices). Moreover, while operations of the method 700B are shown in a particular order, this is not meant to be limiting. One or more operations may be reordered, omitted, and/or added.

At block 760, the system obtains one or more training examples (e.g., in the same or similar manners described with respect to FIGS. 1 and 2, and/or in other manners described herein). Each training example can include a NL based input and a corresponding refined input prompt.

At block 770, the system fine-tunes, based on the one or more training examples, an LLM to generate, based on a given NL based input associated with a client device, a corresponding refined input prompt usable to, in response to user input received at the client device indicative of an acceptance of the corresponding refined input prompt, generate responsive content to the given NL based input based on LLM output generated based on processing the corresponding refined input prompt using the LLM, the responsive content to be caused to be rendered at the client device.

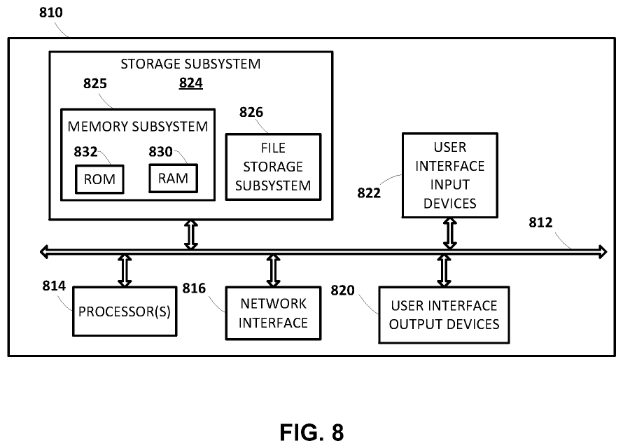

FIG. 8 depicts an example architecture of a computing device, in accordance with various implementations.

Turning now to FIG. 8, a block diagram of an example computing device 810 that may optionally be utilized to perform one or more aspects of techniques described herein is depicted. In some implementations, one or more of a client device, cloud-based automated assistant component(s), and/or other component(s) can include one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some, or all, of the modules described herein. For example, the storage subsystem 824 may include the logic to perform selected aspects of the methods disclosed herein, as well as to implement various components depicted in FIG. 1.

These software modules are generally executed by processor 814 alone or in combination with other processors. Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes: receiving NL based input associated with a client device; generating a refined input prompt corresponding to the NL based input based on first LLM output generated based on processing at least the NL based input using a LLM; causing the refined input prompt to be rendered at the client device; responsive to user input received at the client device indicative of an acceptance of the refined input prompt, generating responsive content to the NL based input based on second LLM output generated based on processing the refined input prompt using the LLM; and causing the responsive content to the NL based input to be rendered at the client device.

These and other implementations of technology disclosed herein can optionally include one or more of the following features.

In some implementations, generating the refined input prompt can be based on processing at least (i) the NL based input and (ii) one or more exemplary refined input prompts using the LLM. In some additional or alternative implementations, the LLM can be fine-tuned to generate, for a given NL based input, a corresponding refined input prompt.

In some additional or alternative implementations, generating the refined input prompt can be based on processing at least (i) the NL based input and (ii) context data using the LLM. In some versions of those implementations. The context data can include user data associated with a user of the client device. In some additional or alternative versions of those implementations, the NL based input can be received as part of a multi-turn dialog with a user of the client device, and the context data can include historical data associated with one or more of the previous turns of the multi-turn dialog.

In some additional or alternative implementations, the method further includes: selecting one or more terms of the refined input prompt to be user selectable terms; and causing an indication of the user selectable terms from among the refined input prompt to be rendered at the client device. In some versions of those implementations, selecting the one or more terms of the refined input prompt to be user selectable terms can be based on metadata included in the first LLM output.

In some additional or alternative versions of those implementations, the method further includes: responsive to detecting user interaction with a particular user selectable term of the one or more user selectable terms at the client device, causing one or more alternative terms corresponding to the particular user selectable term to be rendered at the client device; and responsive to detecting user selection of a particular alternative term at the client device, replacing the particular user selectable term with the particular alternative term in the refined input prompt to generate an updated refined input prompt, wherein the responsive content can be generated based on processing the updated refined input prompt using the LLM in response to user input received at the client device indicative of an acceptance of the updated refined input prompt. In some further versions of those implementations, the method further includes: storing an indication of the selection of the alternative term for use in generating subsequent refined input prompts using the LLM.

In some additional or alternative implementations, the method further includes: causing a graphical user interface element to be rendered at the client device, wherein the refined input prompt is generated in response to user selection of the graphical user interface element at the client device. In some versions of those implementations, the method further includes: determining whether to cause rendering of the graphical user interface element based on a quality metric of the NL based input and/or based on determining that the NL based input includes harmful content.

In some implementations, the responsive content can be first responsive content, and the method further includes: generating second responsive content to the NL based input based on third LLM output generated based on processing the NL based input using the LLM; causing the second responsive content to the NL based input to be rendered at the client device; detecting user input indicative of a selection of one of the first responsive content and the second responsive content at the client device; and in response to the first responsive content being selected: storing the refined input prompt and the NL based input together as a training example for use in fine-tuning the LLM to generate, based on a given NL based input, a corresponding refined input prompt.

In some implementations, the method further includes: modifying the refined input prompt based on user input received at the client device to generate an updated refined input prompt; responsive to user input received at the client device indicative of an acceptance of the updated refined input prompt, generating responsive content to the NL based input based on processing the updated refined input prompt using the LLM; causing the responsive content to the NL based input to be rendered at the client device; and storing the updated refined input prompt and the NL based input together as a training example for use in fine-tuning the LLM to generate, based on a given NL based input, a corresponding refined input prompt.

In some implementations, the method further includes: responsive to the user input received at the client device indicative of the acceptance of the refined input prompt; storing the refined input prompt and the NL based input together as a training example for use in fine-tuning the LLM to generate, based on a given NL based input, a corresponding refined input prompt. In some versions of those implementations, the method further includes: responsive to a user input received at the client device indicative of a request to revert to the NL based input, bypassing storing the refined input prompt and the NL based input as a training example.

In some implementations, the method further includes: fine-tuning the LLM to generate, based on a given NL based input, a corresponding refined input prompt, based on one or more training examples, wherein each training example includes a NL based input and a corresponding refined input prompt.

In some implementations, a method is implemented by one or more processors us provided and includes: obtaining one or more training examples wherein each training example includes a NL based input and a corresponding refined input prompt; fine-tuning, based on the one or more training examples, an LLM to generate, based on a given NL based input associated with a client device, a corresponding refined input prompt usable to, in response to user input received at the client device indicative of an acceptance of the corresponding refined input prompt, generate responsive content to the given NL based input based on LLM output generated based on processing the corresponding refined input prompt using the LLM, the responsive content to be caused to be rendered at the client device.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving natural language (NL) based input associated with a client device;
generating a refined input prompt corresponding to the NL based input based on first large language model (LLM) output generated based on processing at least the NL based input using an LLM;
causing the refined input prompt to be rendered at the client device;
responsive to user input received at the client device indicative of an acceptance of the refined input prompt, generating responsive content to the NL based input based on second LLM output generated based on processing the refined input prompt using the LLM; and
causing the responsive content to the NL based input to be rendered at the client device.

2. The method of claim 1, wherein generating the refined input prompt is based on processing at least (i) the NL based input and (ii) one or more exemplary refined input prompts using the LLM.

3. The method of claim 1, wherein the LLM has been fine-tuned to generate, for a given NL based input, a corresponding refined input prompt.

4. The method of claim 1, wherein generating the refined input prompt is based on processing at least (i) the NL based input and (ii) context data using the LLM.

5. The method of claim 4, wherein the context data comprises user data associated with a user of the client device.

6. The method of claim 4, wherein the NL based input is received as part of a multi-turn dialog with a user of the client device, and wherein the context data comprises historical data associated with one or more of the previous turns of the multi-turn dialog.

7. The method of claim 1, further comprising:
selecting one or more terms of the refined input prompt to be user selectable terms; and
causing an indication of the user selectable terms from among the refined input prompt to be rendered at the client device.

8. The method of claim 7, wherein selecting the one or more terms of the refined input prompt to be user selectable terms is based on metadata included in the first LLM output.

9. The method of claim 7, further comprising:
responsive to detecting user interaction with a particular user selectable term of the one or more user selectable terms at the client device, causing one or more alternative terms corresponding to the particular user selectable term to be rendered at the client device; and
responsive to detecting user selection of a particular alternative term at the client device, replacing the particular user selectable term with the particular alternative term in the refined input prompt to generate an updated refined input prompt,
wherein the responsive content is generated based on processing the updated refined input prompt using the LLM in response to user input received at the client device indicative of an acceptance of the updated refined input prompt.

10. The method of claim 9, further comprising:
storing an indication of the selection of the alternative term for use in generating subsequent refined input prompts using the LLM.

11. The method of claim 1, further comprising:
causing a graphical user interface element to be rendered at the client device, wherein the refined input prompt is generated in response to user selection of the graphical user interface element at the client device.

12. The method of claim 11, further comprising:
determining whether to cause rendering of the graphical user interface element based on a quality metric of the NL based input and/or based on determining that the NL based input comprises harmful content.

13. The method of claim 1, wherein the responsive content is first responsive content, the method further comprising:
generating second responsive content to the NL based input based on third LLM output generated based on processing the NL based input using the LLM;
causing the second responsive content to the NL based input to be rendered at the client device;
detecting user input indicative of a selection of one of the first responsive content and the second responsive content at the client device; and
in response to the first responsive content being selected:
storing the refined input prompt and the NL based input together as a training example for use in fine-tuning the LLM to generate, based on a given NL based input, a corresponding refined input prompt.

14. The method of claim 1, further comprising:
modifying the refined input prompt based on user input received at the client device to generate an updated refined input prompt;
responsive to user input received at the client device indicative of an acceptance of the updated refined input prompt, generating responsive content to the NL based input based on processing the updated refined input prompt using the LLM;
causing the responsive content to the NL based input to be rendered at the client device; and
storing the updated refined input prompt and the NL based input together as a training example for use in fine-tuning the LLM to generate, based on a given NL based input, a corresponding refined input prompt.

15. The method of claim 1, further comprising:
responsive to the user input received at the client device indicative of the acceptance of the refined input prompt;
storing the refined input prompt and the NL based input together as a training example for use in fine-tuning the LLM to generate, based on a given NL based input, a corresponding refined input prompt.

16. The method of claim 15, further comprising:
responsive to a user input received at the client device indicative of a request to revert to the NL based input, bypassing storing the refined input prompt and the NL based input as a training example.

17. The method of claim 1, further comprising:
fine-tuning the LLM to generate, based on a given NL based input, a corresponding refined input prompt, based on one or more training examples, wherein each training example comprises a NL based input and a corresponding refined input prompt.

18. A method implemented by one or more processors, the method comprising:
obtaining one or more training examples wherein each training example comprises a NL based input and a corresponding refined input prompt;
fine-tuning, based on the one or more training examples, an LLM to generate, based on a given NL based input associated with a client device, a corresponding refined input prompt usable to, in response to user input received at the client device indicative of an acceptance of the corresponding refined input prompt, generate responsive content to the given NL based input based on LLM output generated based on processing the corresponding refined input prompt using the LLM, the responsive content to be caused to be rendered at the client device.

19. A system comprising:
one or more hardware processors; and
memory storing instructions that, when executed by the one or more hardware processors, cause the one or more hardware processors to perform operations according to the method of claim 1.

20. A non-transitory computer-readable storage medium storing instructions that, when executed by one or more hardware processors, cause the one or more hardware processors to perform operations according to the method of claim 1.
